(19) United States
(12) Patent Application Publication
(10) Pub. No.: US 2026/0280210 A1
(43) Pub. Date: Sep. 17, 2026

(54) ROLLING BRUSH FOR ELECTRIC MOTOR

(71) Applicant: Schaeffler Technologies AG & Co. KG, Herzogenaurach (DE)

(72) Inventors: Aviral Gupta, Troy, MI (US); Colin Foster, Belle River (CA); Faheem Ahmed, Rochester Hills, MI (US)

(21) Appl. No.: 19/081,706

(22) Filed: Mar. 17, 2025

(51) Int. Cl. H01R 39/12; H01R 39/36; H01R 39/39; H02K 13/00

(52) U.S. Cl. CPC H01R 39/12; H01R 39/36; H01R 39/39; H02K 13/003

(57) ABSTRACT

Rolling brushes may provide a rolling contact to transmit current to a rotating slip-ring. The rolling brushes may have reduced wear and heat build-up, as compared to sliding brushes. The rolling brushes may be used in combination with brush holders, springs, and wires to provide radial translation and with an electrical connection. The rolling brushes, brush holders, springs, and wires may be held by inner and outer brush carriers. Pairs of the inner and outer brush carriers may be affixed to opposing axial sides of a housing plate. The wires may couple to pairs of plate rings which may also be affixed to opposing axial sides of a housing plate. The rolling brushes may roll on slip-rings as the slip-rings rotate relative to the housing plate.

### TECHNICAL FIELD

The present disclosure generally relates to rotary current collectors, and more particularly, to slip-rings using roller contacts.

### BACKGROUND

There is an increasing demand for rare earth metals to make the magnets for the rotor of the permanent magnet synchronous motors. These metals are not only limited and expensive to mine, the mining and refining process has a large carbon footprint. These metals can also be difficult to source due to geopolitical issues.

Alternatively, an electromagnet can be used instead of permanent magnets in the rotor of electrically excited synchronous motors. The electromagnet offers additional benefits in motor control, and overall longevity of the motor. For the electromagnet, the rotor needs to be energized by direct current. This electromagnet requires the current to be transmitted from a fixed terminal to a rotating rotor. The current is transmitted using a sliding contact between a fixed brush and a rotating slip-ring. The sliding contact causes mechanical wear and heat from friction which has negative effects on the life of the parts. Therefore, it would be advantageous to provide a device, system, and method that cures the shortcomings described above.

### SUMMARY

A current collector is described, in accordance with one or more embodiments of the present disclosure. The current collector may include: a first plate ring; a second plate ring; a housing plate, wherein the housing plate is electrically non-conductive; a first brush assembly, wherein the first plate ring and the first brush assembly are affixed to a same axial side of the housing plate; a second brush assembly, wherein the second plate ring and the second brush assembly are affixed to a same axial side of the housing plate, wherein the first brush assembly and the second brush assembly include a plurality of wires, a plurality of springs, a plurality of brush holders, and a plurality of rolling brushes; and a slip-ring module, wherein the slip-ring module is configured to rotate relative to the housing plate, the first brush assembly, and the second brush assembly about a center axis, wherein the slip-ring module includes a first slip-ring and a second slip-ring, wherein the plurality of rolling brushes of the first brush assembly and the second brush assembly include rolling contact with respective of the first slip-ring and the second slip-ring as the slip-ring module rotates about the center axis, wherein the plurality of wires, the plurality of brush holders, and the plurality of rolling brushes of the first brush assembly and the second brush assembly are configured to transmit current between respective of the first plate ring and the second plate ring and respective of the first slip-ring and the second slip-ring.

In some aspects, the first plate ring and the second plate ring are affixed to opposing axial sides of the housing plate, wherein the first brush assembly and the second brush assembly include an outer brush carrier and an inner brush carrier, wherein the inner brush carrier is axially aligned with and disposed radially within the outer brush carrier, wherein the outer brush carrier and the inner brush carrier carry the plurality of wires, the plurality of springs, the plurality of brush holders, and the plurality of rolling brushes.

In some aspects, the plurality of wires of the first brush assembly and the second brush assembly couple between respective of the first plate ring and the second plate ring and the plurality of springs, wherein the plurality of springs couple between the plurality of brush holders and the outer brush carrier, wherein the plurality of brush holders are disposed radially inwards of the plurality of wires and the plurality of springs, wherein the plurality of brush holders are disposed radially outwards of the plurality of rolling brushes, wherein the plurality of rolling brushes are forced radially inwards by the plurality of springs via the plurality of brush holders.

In some aspects, the plurality of springs are compression springs, wherein the plurality of wires radially extend through an inner diameter of the plurality of springs.

In some aspects, radially-inner ends of the plurality of wires, radially-inner ends of the plurality of springs, the plurality of brush holders, and the plurality of rolling brushes are configured to radially translate relative to the outer brush carrier and the inner brush carrier, wherein the radially-inner ends of the plurality of springs and the radially-inner ends of the plurality of wires couple to radially-outer ends of the plurality of brush holders, wherein the radially-outer ends of the plurality of springs couple to the outer brush carrier, wherein radially-outer ends of the plurality of wires of the first brush assembly and the second brush assembly couple to respective of the first plate ring and the second plate ring.

In some aspects, the radially-outer ends of the plurality of wires includes a U-shape.

In some aspects, the outer brush carrier and the inner brush carrier cooperatively define a plurality of brush holes, wherein the plurality of brush holes extend radially outwards from an inner diameter of the inner brush carrier up through a portion of the outer brush carrier, wherein the plurality of brush holes carry the plurality of wires, the plurality of springs, the plurality of brush holders, and the plurality of rolling brushes, wherein the plurality of brush holes include an inward taper at an inner diameter of the inner brush carrier, wherein the inward taper retains the plurality of rolling brushes within the plurality of brush holes.

In some aspects, the outer brush carrier includes a star shape defining a plurality of vertices, wherein the radially-outer ends of the plurality of springs couple to plurality of vertices within the plurality of brush holes.

In some aspects, the housing plate defines an oil inlet and a pair of circumferential grooves, wherein the oil inlet fluidically couples with the pair of circumferential grooves, wherein the inner brush carrier defines an oil bore, wherein the oil bore fluidically couples the pair of circumferential grooves with the plurality of brush holes.

In some aspects, the current collector is configured to be oil-cooled via the oil inlet, the pair of circumferential grooves, and the oil bore.

In some aspects, the housing plate defines a plate portion and a rim portion, wherein the rim portion is disposed radially around and axially extends from the plate portion, wherein the plate portion defines the pair of the circumferential grooves, wherein the plate portion and the rim portion collectively define the oil inlet.

In some aspects, the first brush assembly and the second brush assembly are affixed axially within the housing plate, wherein the first brush assembly and the second brush assembly include an first axial brush carrier and a second axial brush carrier, wherein the first axial brush carrier is axially offset from and radially aligned with the second axial brush carrier, wherein the first axial brush carrier and the second axial brush carrier carry the plurality of wires, the plurality of springs, the plurality of brush holders, and the plurality of rolling brushes.

In some aspects, the plurality of rolling brushes include one of ball rollers, needle rollers, or taper rollers.

In some aspects, the plurality of rolling brushes include the ball rollers, wherein a radially-inner end of the plurality of brush holders includes a curvature conforming to the plurality of rolling brushes, wherein the first slip-ring and the second slip-ring define a raceway, wherein the plurality of rolling brushes abut to and are configured to roll on the raceway.

In some aspects, the slip-ring module includes an overmolding, wherein the overmolding electrically insulates the first slip-ring and the second slip-ring from each other.

In some aspects, the slip-ring module includes a first terminal end and a second terminal end, wherein the first slip-ring and the second slip-ring are electrically connected to respective of the first terminal end and the second terminal end within the overmolding.

In some aspects, the first terminal end and the second terminal end are axially offset and disposed radially outward of the first slip-ring and the second slip-ring.

In some aspects, the overmolding includes a first annular portion, a first leg portion, a second leg portion, and a second annular portion, wherein the first annular portion and the second annular portion are concentric to the center axis, wherein the first annular portion is disposed radially inwards of and axially aligned with the first slip-ring and the second slip-ring, wherein the first leg portion and the second leg portion extend between and couple the first annular portion and the second annular portion, wherein the first terminal end and the second terminal end radially extend from the second annular portion.

In some aspects, the first plate ring and the second plate ring include an annular portion and terminal portion, wherein the terminal portion extends from an outer diameter of the annular portion, wherein the plurality of wires are coupled to the annular portion.

A dynamo-electric machine is described, in accordance with one or more embodiments of the present disclosure. The dynamo-electric machine may include: a current collector including: a first plate ring; a second plate ring; a housing plate, wherein the housing plate is electrically non-conductive; a first brush assembly, wherein the first plate ring and the first brush assembly are affixed to a same axial side of the housing plate; a second brush assembly, wherein the second plate ring and the second brush assembly are affixed to a same axial side of the housing plate, wherein the first brush assembly and the second brush assembly include a plurality of wires, a plurality of springs, a plurality of brush holders, and a plurality of rolling brushes; and a slip-ring module, wherein the slip-ring module is configured to rotate relative to the housing plate, the first brush assembly, and the second brush assembly about a center axis, wherein the slip-ring module includes a first slip-ring and a second slip-ring, wherein the plurality of rolling brushes of the first brush assembly and the second brush assembly include rolling contact with respective of the first slip-ring and the second slip-ring as the slip-ring module rotates about the center axis, wherein the plurality of wires, the plurality of brush holders, and the plurality of rolling brushes of the first brush assembly and the second brush assembly are configured to transmit current between respective of the first plate ring and the second plate ring and respective of the first slip-ring and the second slip-ring; a rotor, wherein the rotor includes a shaft and a rotor winding, wherein the slip-ring module is affixed to the shaft, wherein the current collector is configured to supply current to the rotor winding as the rotor rotates about the center axis; a stator; and a motor housing, wherein the motor housing houses the rotor and the stator, wherein the housing plate and the stator are affixed to the motor housing.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A illustrates a perspective view of a current collector, in accordance with one or more embodiments of the present disclosure.

FIG. 1B illustrates a partial perspective cross-section view of the current collector with an inner brush carrier hidden to show a rolling brush, in accordance with one or more embodiments of the present disclosure.

FIG. 1C illustrates a partial perspective cross-section view of the current collector with an inner brush carrier hidden to show the rolling brush and a circumferential groove, in accordance with one or more embodiments of the present disclosure.

FIG. 1D illustrates an exploded view of the current collector, in accordance with one or more embodiments of the present disclosure.

FIG. 1E illustrates a perspective view of a housing plate of the current collector, in accordance with one or more embodiments of the present disclosure.

FIG. 1F illustrates a perspective view of a brush assembly of the current collector, in accordance with one or more embodiments of the present disclosure.

FIG. 1G illustrates a front cross-section view of the brush assembly, in accordance with one or more embodiments of the present disclosure.

FIG. 1H illustrates a side cross-section view of the brush assembly, in accordance with one or more embodiments of the present disclosure.

FIG. 1I illustrates a partial side cross-section view of the brush assembly, in accordance with one or more embodiments of the present disclosure.

FIGS. 1J and 1K illustrate exploded views of the brush assembly, in accordance with one or more embodiments of the present disclosure.

FIG. 1L illustrates a perspective view of a slip-ring module of the current collector, in accordance with one or more embodiments of the present disclosure.

FIG. 2 illustrates a partial cross-section view of a dynamo-electric machine including the current collector, in accordance with one or more embodiments of the present disclosure.

FIG. 3A illustrates a partial cross-section view of the current collector, in accordance with one or more embodiments of the present disclosure.

FIGS. 3B-3C illustrate a partial cross-section view of the brush assembly, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to rolling brushes for an electric motor. The rolling brushes may provide a rolling contact to transmit current to a rotating slip-ring. The rolling brushes may have reduced wear and heat build-up, as compared to sliding brushes. The rolling brushes may be used in combination with brush holders, springs, and wires to provide radial translation and with an electrical connection. The rolling brushes, brush holders, springs, and wires may be held by inner and outer brush carriers. Pairs of the inner and outer brush carriers may be affixed to opposing axial sides of a housing plate. The wires may couple to pairs of plate rings which may also be affixed to opposing axial sides of a housing plate. The rolling brushes may roll on slip-rings as the slip-rings rotate relative to the housing plate.

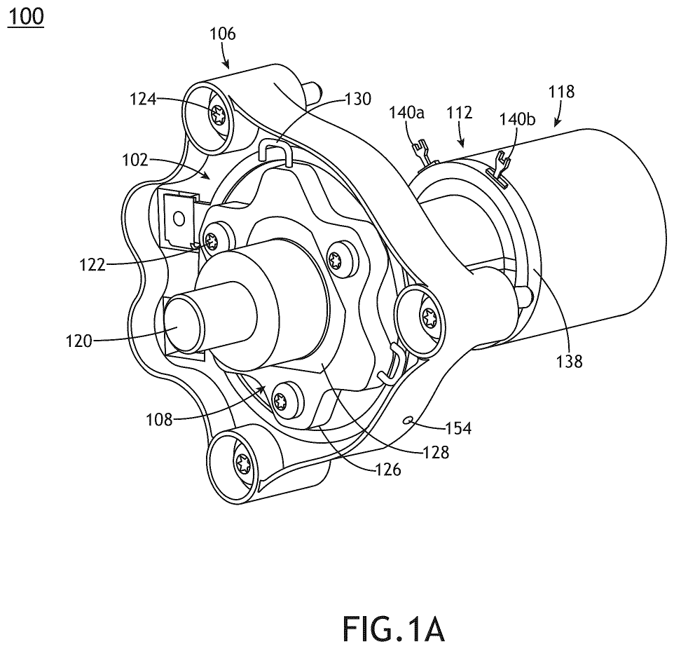

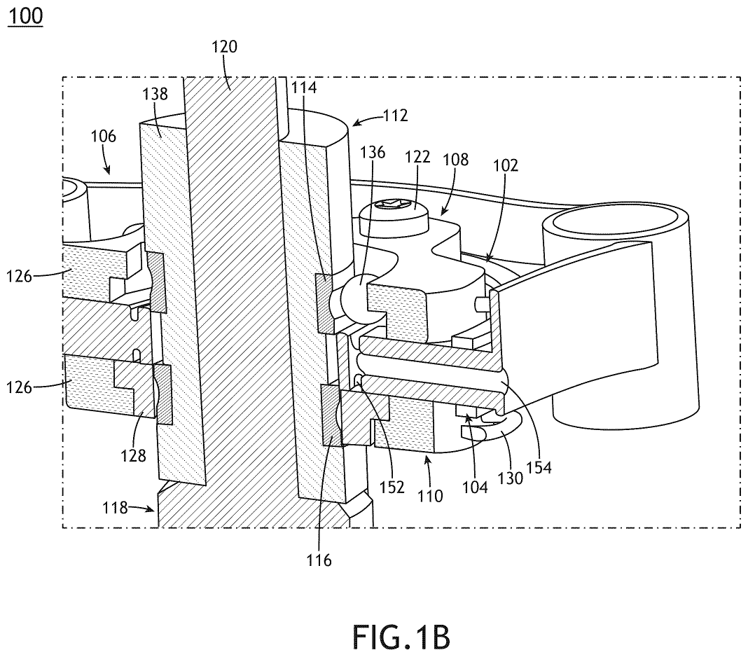

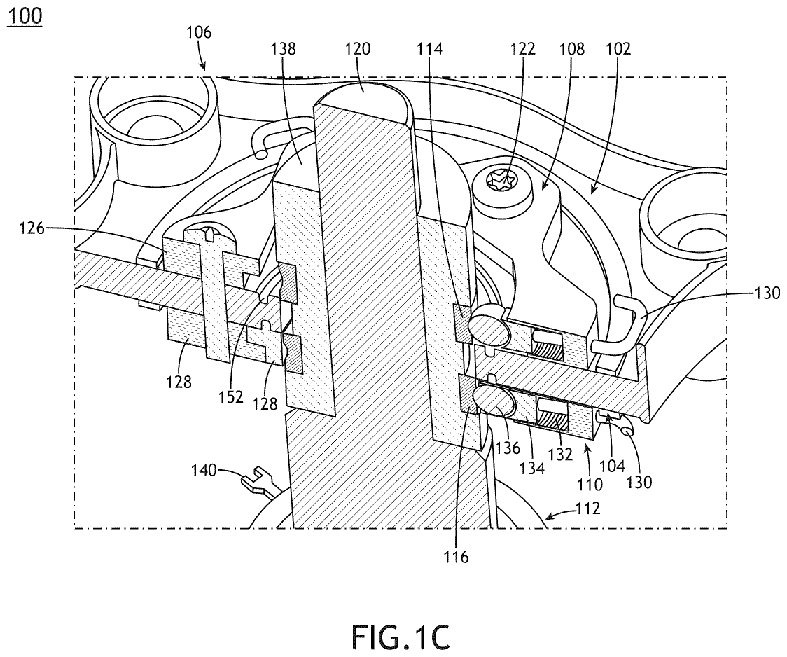

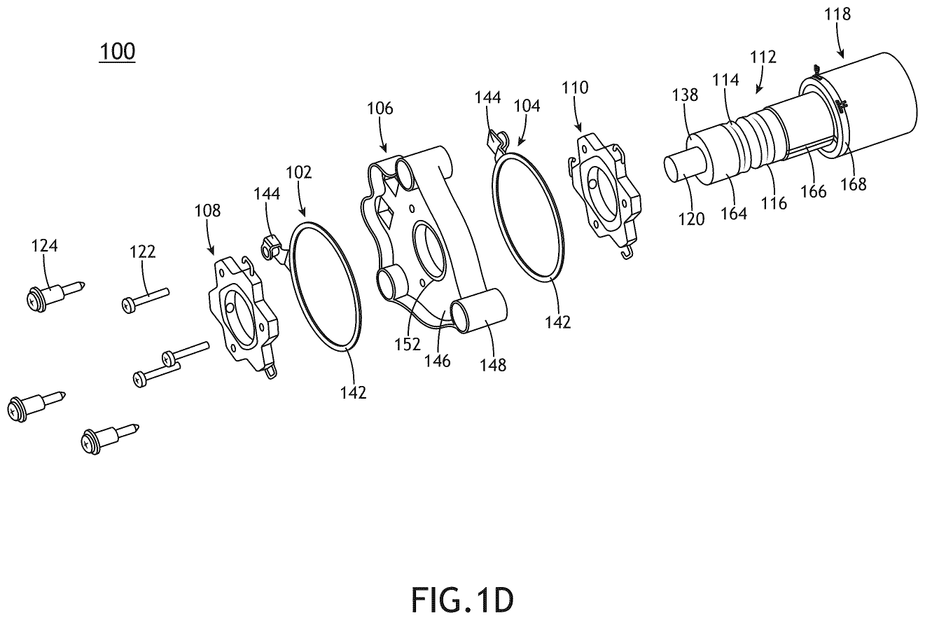

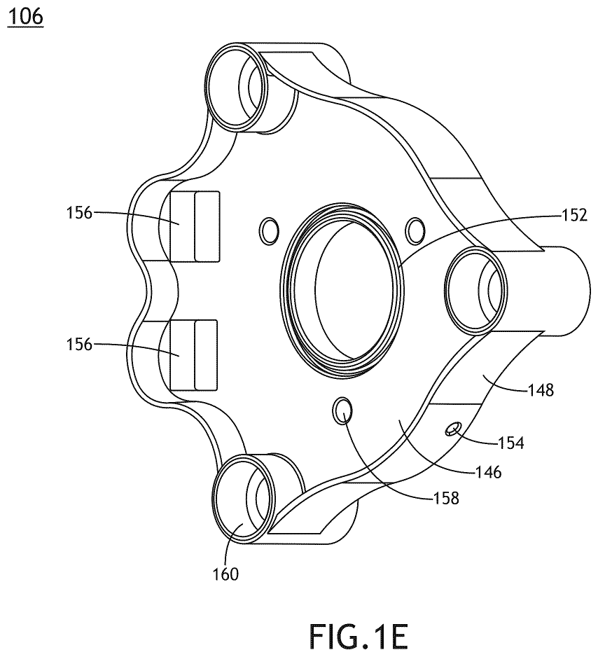

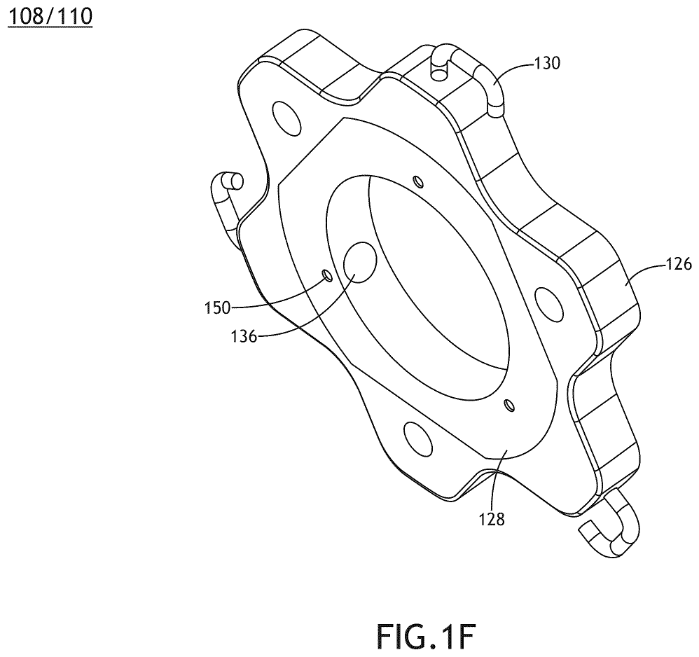

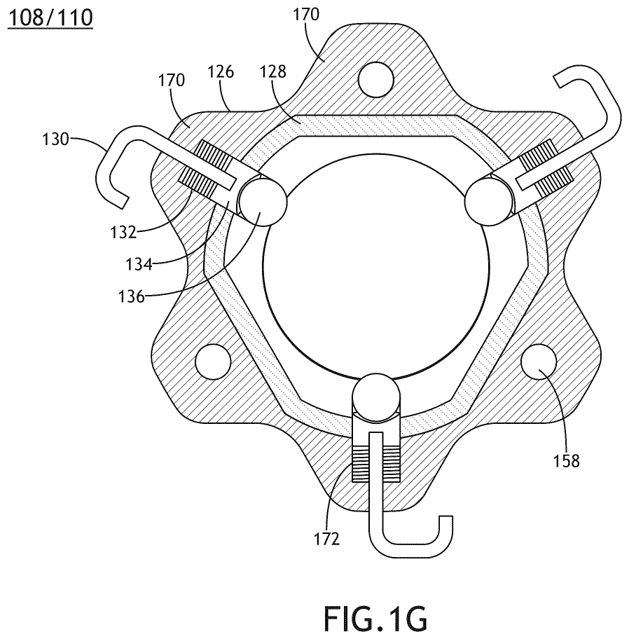

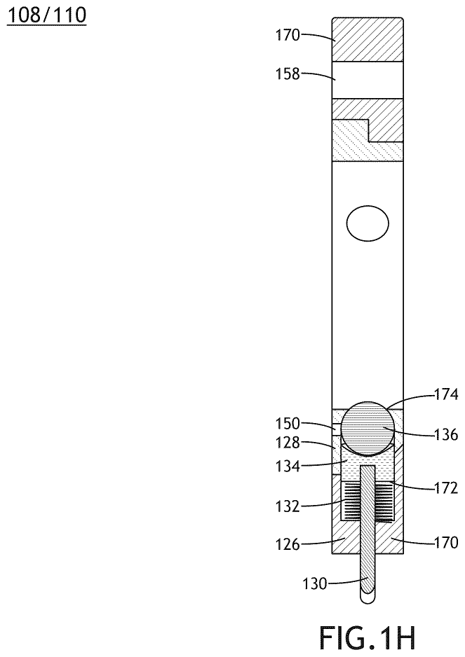

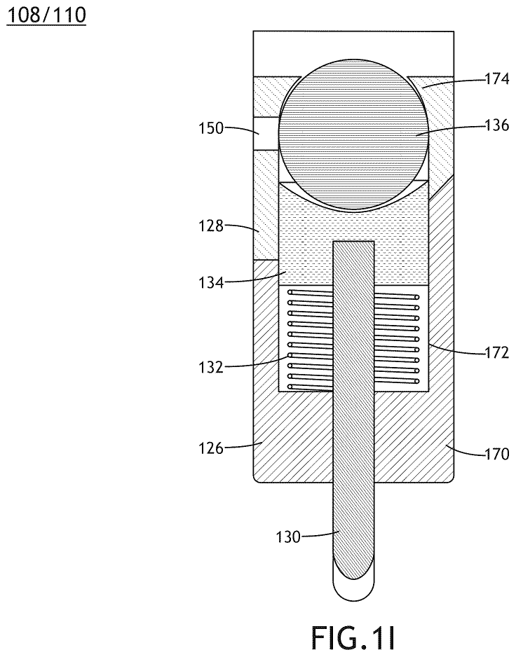

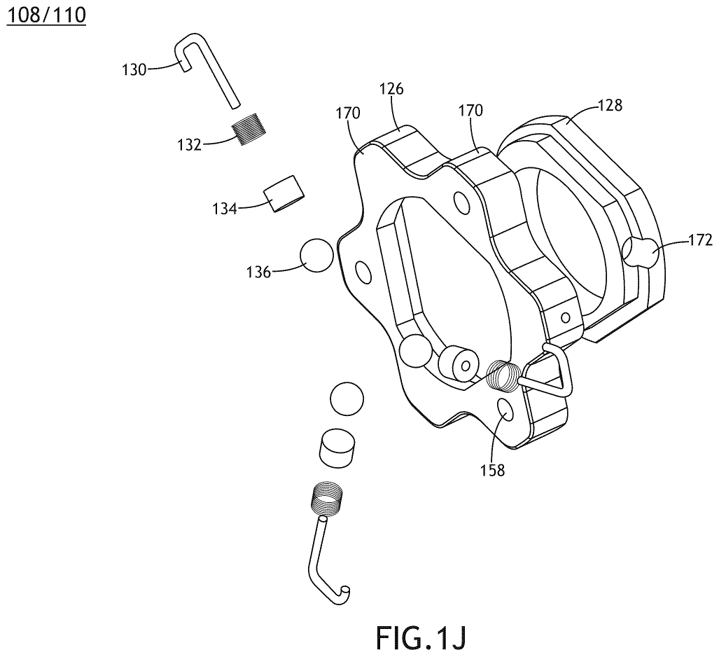

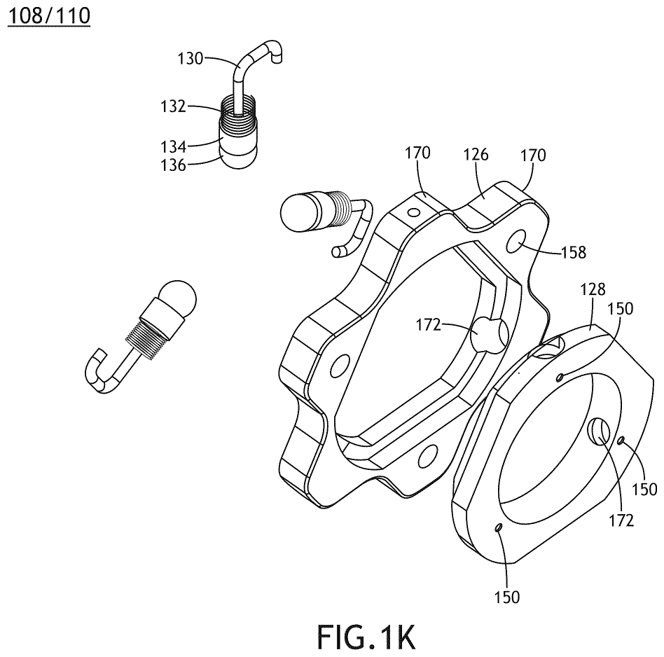

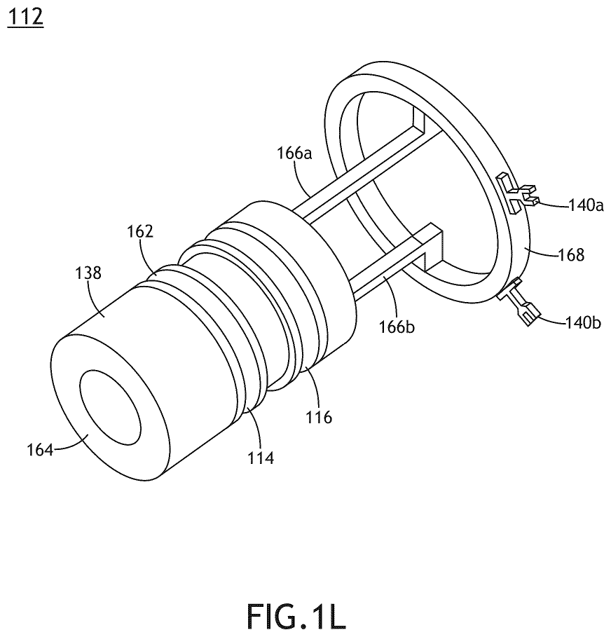

FIGS. 1A-1L illustrate a current collector 100, in accordance with one or more embodiments of the present disclosure. The current collector 100 may be a rotary current collector, a wet power transmission system, or the like. The current collector 100 may be a connector with an unlimited rotation angle.

The current collector 100 may include one or more components, such as, but not limited to, a first plate ring 102, a second plate ring 104, a housing plate 106, a first brush assembly 108, a second brush assembly 110, a slip-ring module 112, a first slip-ring 114, a second slip-ring 116, a rotor 118, a shaft 120, fasteners 122, fasteners 124, outer brush carriers 126, inner brush carriers 128, wires 130, springs 132, brush holders 134, rolling brushes 136, overmolding 138, and/or terminal ends 140.

The first plate ring 102 and the second plate ring 104 may be affixed to opposing axial sides of the housing plate 106.

The first plate ring 102 and the second plate ring 104 may include an annular portion 142 and terminal portion 144. The annular portion 142 and the terminal portion 144 may be coupled. For example, the terminal portion 144 may extend from an outer diameter of the annular portion 142. The annular portion 142 may be concentric to a center axis of the current collector 100. The first plate ring 102 and the second plate ring 104 may be electrically conductive. The terminal portion 144 may provide a means for coupling current into and out of the first plate ring 102 and/or the second plate ring 104.

The housing plate 106 may be electrically non-conductive. The housing plate 106 may electrically insulate the first plate ring 102 from the second plate ring 104. The housing plate 106 may define one or more portions. For example, the housing plate 106 may define a plate portion 146 and/or a rim portion 148. The rim portion 148 may be disposed radially around and axially extend from the plate portion 146. In this regard, an axial thickness of the rim portion 148 may be larger than an axial thickness of the plate portion 146. One or more components of the current collector may be affixed to the plate portion 146 and/or to the rim portion 148. For example, the first plate ring 102, the second plate ring 104, the first brush assembly 108, the second brush assembly 110, and/or the fasteners 122 may be affixed to the plate portion 146. By way of another example, the fasteners 124 may be affixed to the rim portion 148.

The plate portion 146 may define radially-offset through holes 156. The radially-offset through holes 156 may be parallel to and radially-offset from the center axis of the current collector. The radially-offset through holes 156 may include a select shape, such as, but not limited to, a rectangular shape. The terminal portion 144 of each of the first plate ring 102 and the second plate ring 104 may be disposed in respective of the radially-offset through holes 156.

The plate portion 146 and the rim portion 148 may define fastener holes 158 and fastener holes 160, respectively. The fasteners 122 and the fasteners 124 may be fastened to the housing plate 106 via the fastener holes 158 and the fastener holes 160, respectively. The fastener holes 158 and fastener holes 160 may be parallel to and radially-offset from the center axis of the current collector. The fastener holes 158 and fastener holes 160 may include any suitable type of fastener hole, such as, but not limited to, through holes, threaded holes, countersunk holes, and the like. For example, the fastener holes 158 and the fastener holes 160 may be through holes and countersunk holes, respectively.

The first brush assembly 108 and the second brush assembly 110 may be affixed to opposing axial sides of the housing plate 106. Affixing the first brush assembly 108 and the second brush assembly 110 to opposing axial sides of the housing plate 106 may be beneficial to reduce an axial and radial space of the current collector 100. The first plate ring 102 and the second plate ring 104 may be disposed radially outwards of the first brush assembly 108 and the second brush assembly 110. The first plate ring 102 and the first brush assembly 108 may be affixed to a same axial side of the housing plate 106. For example, the first plate ring 102 and the first brush assembly 108 may be affixed to as same axial side of the plate portion 146 of the housing plate 106. Similarly, the second plate ring 104 and the second brush assembly 110 may be affixed to a same axial side of the housing plate 106. For example, the second plate ring 104 and the second brush assembly 110 may be affixed to a same axial side of the plate portion 146 of the housing plate 106.

The rotor 118 may include a shaft 120. The shaft 120 may be concentric with the center axis of the current collector 100. The slip-ring module 112 may be affixed to the rotor 118. The slip-ring module 112 and the rotor 118 may rotate together about the center axis, relative to the housing plate 106, the first brush assembly 108, and/or the second brush assembly 110. The shaft 120 may be a radially-innermost portion of the current collector 100.

The fasteners 122 and the fasteners 124 may include any suitable fasteners, such as, but not limited to, bolts, screws, rivets, or the like. The fasteners 122 may affix together the housing plate 106, the first brush assembly 108, and the second brush assembly 110. The fasteners 122 may affix together the housing plate 106, the first brush assembly 108, and the second brush assembly 110 through the fastener holes 158. The fasteners 124 may be affixed to the fastener holes 160.

The first brush assembly 108 and the second brush assembly 110 may include the outer brush carriers 126 and the inner brush carriers 128. For example, each of the first brush assembly 108 and the second brush assembly 110 may include one of the outer brush carriers 126 and one of the inner brush carriers 128. The outer brush carriers 126 and the inner brush carriers 128 may be affixed together. The inner brush carriers 128 may be axially aligned with and disposed radially within the outer brush carriers 126. The outer brush carriers 126 and the inner brush carriers 128 may be electrically conductive or electrically non-conductive without impacting the function of the current collector 100. The outer brush carriers 126 and the inner brush carriers 128 may be affixed to the housing plate 106. For example, the fasteners 122 may affix the outer brush carriers 126 to the housing plate 106. The outer brush carriers 126 may abut the inner brush carriers 128 to the housing plate 106, thereby affixing the inner brush carriers 128 to the housing plate 106.

The outer brush carriers 126 may include a select shape. For example, the outer brush carriers 126 may be a star shape (as depicted), a circle, or the like. For instance, the star shape may be a six-pointed star shape. The star shape may define vertices 170. The vertices 170 may be defined in a polar array about the center axis of the current collector 100. The six-pointed star shape may be beneficial to reduce a material and/or weight of the outer brush carriers 126. The fasteners 122 may be affixed to the outer brush carriers 126 at one or more of the vertices 170 of the outer brush carriers 126. For example, the vertices 170 of the outer brush carriers 126 may also define the fastener holes 158 which may be circumferentially aligned with the fastener holes 158 defined by the housing plate 106, through which the fasteners 122 may affix together the housing plate 106, the first brush assembly 108, and the second brush assembly 110. The wires 130 and the springs 132 may radially extend through and abut to, respectively, a remainder of the vertices 170 of the outer brush carriers 126.

The first brush assembly 108 and the second brush assembly 110 may include the wires 130, the springs 132, the brush holders 134, and the rolling brushes 136. Each of the first brush assembly 108 and the second brush assembly 110 may include a select number of the wires 130, the springs 132, the brush holders 134, and the rolling brushes 136. For example, the first brush assembly 108 and the second brush assembly 110 may each include a set of three (as depicted), four, five, six, or more of the wires 130, the springs 132, the brush holders 134, and the rolling brushes 136. The wires, the springs 132, the brush holders 134, and the rolling brushes 136 of each of the first brush assembly 108 and the second brush assembly 110 may be arranged in polar arrays about the center axis of current collector 100. In this regard, the rolling brushes 136 may be evenly distributed about the first slip-ring 114 and/or the second slip-ring 116. The polar arrays of the wires, the springs 132, the brush holders 134, and the rolling brushes 136 in the first brush assembly 108 may or may not be aligned with the polar arrays of the wires, the springs 132, the brush holders 134, and the rolling brushes 136 in the second brush assembly 110. As depicted, the polar arrays are aligned.

The outer brush carriers 126 and the inner brush carriers 128 may cooperatively define brush holes 172. Portions of the brush holes 172 defined by the outer brush carriers 126 and portions of the brush holes 172 defined by the inner brush carriers 128 may be circumferentially aligned by which the brush holes 172 may be cooperatively defined. The portions of the brush holes 172 defined by the inner brush carriers 128 may be through holes. The portions of the brush holes 172 defined by the outer brush carriers 126 may be blind holes. The brush holes 172 may extend radially outwards from an inner diameter of the inner brush carriers 128 up through a portion of the outer brush carriers 126. For example, the brush holes 172 may be defined up to the vertices 170 of the outer brush carriers 126. The brush holes 172 may be defined in a polar array about the center axis of the current collector 100.

The outer brush carriers 126 and the inner brush carriers 128 may carry the wires 130, the springs 132, the brush holders 134, and the rolling brushes 136. The brush holes 172 may also be referred to as brush guides, radial channels, or the like. The brush holes 172 may carry the wires 130, the springs 132, the brush holders 134, and the rolling brushes 136. For example, a radially-inner portion of the wires 130, the springs 132, the brush holders 134, and a radially-outer portion of the rolling brushes 136 may be disposed within the brush holes 172. A radially-outer portion of the wires 130 may extend through the brush holes 172 and be disposed radially outwards of outer brush carriers 126. A radially-inner portion of the rolling brushes 136 may extend through the brush holes 172 and be disposed radially inwards of the inner brush carriers 128.

The brush holes 172 may prevent the radially-inner ends of the wires 130, the springs 132, the brush holders 134, and/or the rolling brushes 136 from axial translation and/or circumferential translation relative to the outer brush carriers 126 and the inner brush carriers 128. The radially-inner ends of the wires 130, the radially-inner ends of the springs 132, the brush holders 134, and/or the rolling brushes 136 may be configured to radially translate relative to the outer brush carriers 126 and the inner brush carriers 128. The radially-inner ends of the wires 130, the radially-inner ends of the springs 132, the brush holders 134, and the rolling brushes 136 may be configured to radially translate along the brush holes 172. A diameter of the brush holes 172 may be larger than the wires 130, the springs 132, the brush holders 134, and the rolling brushes 136 by which the radially-inner ends of the wires 130, the radially-inner ends of the springs 132, the brush holders 134, and the rolling brushes 136 may be configured to radially translate along the brush holes 172.

The wires 130 of the first brush assembly 108 and the second brush assembly 110 may couple between respective of the first plate ring 102 and the second plate ring 104 and the springs 132. For example, the wires 130 of the first brush assembly 108 may couple between the first plate ring 102 and the springs 132 of the first brush assembly 108. By way of another example, the wires 130 of the second brush assembly 110 may couple between the second plate ring 104 and the springs 132 of the second brush assembly 110.

A radially-inner end of wires 130 may be coupled to a radially-outer end of the brush holders 134. A radially-outer end of the wires 130 of the first brush assembly 108 and the second brush assembly 110 may be coupled to respective of the first plate ring 102 and the second plate ring 104. The wires 130 may be coupled to the annular portion 142 of the first plate ring 102 and the second plate ring 104. The radially-outer end of the wires 130 may include a select shape. For example, the radially-outer end of the wires 130 may include a U-shape. The U-shape may provide elastic deformation and enable radial movement of the wires 130.

The springs 132 may couple between the brush holders 134 and the outer brush carriers 126. For example, a radially-inner end of the springs 132 may couple to the radially-outer end of the brush holders 134 and a radially-outer end of the springs 132 may couple to the outer brush carriers 126. For instance, the radially-outer end of the springs 132 may couple to vertices 170 of the outer brush carriers 126 within the brush holes 172. The springs 132 may be compression springs. The springs 132 may force the brush holders 134 radially inwards (e.g., spring-load). The wires 130 may radially extend through an inner diameter of the springs 132.

The brush holders 134 may be disposed radially inwards of the wires 130 and the springs 132 and disposed radially outwards of the rolling brushes 136. The radially-outer end of the brush holders 134 to which the wires 130 and the springs 132 are coupled may be flat. A radially-inner end of the brush holders 134 may couple to a radially-outer end of the rolling brushes 136. The radially-inner end of the brush holders 134 may include a curvature. The curvature may conform to the rolling brushes 136.

The rolling brushes 136 may be forced radially inwards by the springs 132 via the brush holders 134. The force of the brush holders 134 radially inwards by the springs 132 may force the rolling brushes 136 radially inwards. The rolling brushes 136 of the first brush assembly 108 and the second brush assembly 110 may be forced against respective of the first slip-ring 114 and the second slip-ring 116. For example, the rolling brushes 136 may be forced against a raceway of the first slip-ring 114 and the second slip-ring 116.

The rolling brushes 136 of the first brush assembly 108 and the second brush assembly 110 may have rolling contact with respective of the first slip-ring 114 and the second slip-ring 116 as the slip-ring module 112 rotates about the center axis. The force of the rolling brushes 136 of the first brush assembly 108 and the second brush assembly 110 against respective of the first slip-ring 114 and the second slip-ring 116, may cause the rolling brushes 136 to roll as the first slip-ring 114 and the second slip-ring 116 rotate relative to the rolling brushes 136 about the center axis of the current collector 100. Thus, the rolling brushes 136 may be configured to roll as the first slip-ring 114 and the second slip-ring 116 rotate relative to the rolling brushes 136 about the center axis of the current collector 100. The rolling brushes 136 may be elastically supported brushes for reducing noise or vibrations associated with the rotation of the first slip-ring 114 and the second slip-ring 116 (e.g., to compensate for eccentricities in slip-ring diameter around the circumference, for wear of the brush holders 134, and/or for wear of the rolling brushes 136). By regulating the force of the spring 132, a contact pressure of the rolling brushes 136 may be set so that it is optimal for the specific application, thus contributing to improved performance of the current collector 100. Furthermore, the force may compensate for shocks and vibrations that can occur during operation.

The brush holes 172 may include an inward taper 174 at the inner diameter of the inner brush carriers 128. The inward taper 174 may retain the rolling brushes 136 within the brush holes 172. For example, a diameter of the inward taper 174 may be less than the diameter of the rolling brushes 136 by which the inward taper 174 may retain the portion of the rolling brushes 136 within the brush holes 172. The radially inner portion of the rolling brushes 136 may extend through the inward taper 174 towards the center axis of the current collector 100. Thus, the rolling brushes 136 may be held and stick out radially inwards through the inward taper 174 without falling out.

The rolling brushes 136 may be any suitable type of rolling element. For example, the rolling brushes 136 may be ball rollers (as depicted), needle rollers, taper rollers, or the like. The brush holders 134 and/or the rolling brushes 136 may include a select material and/or surface finishes for reducing wear with the rolling of the rolling brushes 136. For example, the brush holders 134 may be carbon brush holders.

The rolling brushes 136 of the first brush assembly 108 may be held in position between the brush holders 134 and the first slip-ring 114. Similarly, the rolling brushes 136 of the second brush assembly 110 may be held in position between the brush holders 134 and the second slip-ring 116. The first slip-ring 114 and the second slip-ring 116 may rotate relative to the rolling brushes 136. The rolling brushes 136 may roll on the first slip-ring 114 and the second slip-ring 116. The rolling brushes 136 may rotate about a center axis of the rolling brushes 136 when rolling on the first slip-ring 114 and the second slip-ring 116. From the perspective of the first slip-ring 114 and the second slip-ring 116, the rolling brushes 136 may exhibit orbital motion. For example, the orbital motion may be caused by the rotation of the first slip-ring 114 and the second slip-ring 116 about the center axis of the current collector 100 while the rolling brushes 136 are fixed in position relative to the center axis together with the rotation of the rolling brushes 136 about the center axes of the rolling brushes 136.

The wires 130, the brush holders 134, and/or the rolling brushes 136 may be electrically conductive. The wires 130 may electrically connect to the rolling brushes 136 through the brush holders 134. The wires 130, the brush holders 134, and the rolling brushes 136 of the first brush assembly 108 and the second brush assembly 110 may transmit current between the respective of the first plate ring 102 and the second plate ring 104 and respective of the first slip-ring 114 and the second slip-ring 116. For example, the first brush assembly 108 may transmit current between the first plate ring 102 and the first slip-ring 114 via the wires 130, the brush holders 134, and the rolling brushes 136 of the first brush assembly 108. By way of another example, the second brush assembly 110 may transmit current between the second plate ring 104 and the second slip-ring 116 via the wires 130, the brush holders 134, and the rolling brushes 136 of the second brush assembly 110. The rolling of the rolling brushes 136 may enable rotation of the first slip-ring 114 and the second slip-ring 116 while maintaining the electrical connection.

The springs 132 may be electrically conductive or electrically non-conductive without impacting the function of the current collector 100. Thus, the current collector 100 may provide uninterrupted current collection.

The slip-ring module 112 may include the first slip-ring 114, the second slip-ring 116, the overmolding 138, and/or the terminal ends 140.

The first slip-ring 114 and the second slip-ring 116 may be concentric to the center axis of the current collector 100. The first slip-ring 114 and the second slip-ring 116 may be axially offset on the slip-ring module 112. The first slip-ring 114 and the second slip-ring 116 may be disposed radially inwards of and axially aligned with respective of the first brush assembly 108 and the second brush assembly 110. The first slip-ring 114 and the second slip-ring 116 may define raceways 162 along an outer radius. The rolling brushes 136 may abut to and be configured to roll on the raceways 162. The raceways 162 may promote the interaction with the rolling brushes 136. The rolling brushes 136 may conform to the raceways 162 as the rolling brushes 136 roll and as the raceways 162 rotate about the center axis.

The first slip-ring 114 and the second slip-ring 116 may be electrically conductive. The raceways 162 may form an electrical connection with the rolling brushes 136.

The overmolding 138 may be electrically non-conductive. The overmolding 138 may electrically insulate the first slip-ring 114 and the second slip-ring 116 from each other. The overmolding 138 may also electrically insulate the terminal ends 140 from each other.

The overmolding 138 may include one or more portions. For example, the overmolding 138 may include a first annular portion 164, leg portions 166, and/or a second annular portion 168. The first annular portion 164 and the second annular portion 168 may be concentric to the center axis of the current collector 100. The first annular portion 164 may be affixed to the shaft 120. The first annular portion 164 may be disposed radially inwards of and axially aligned with the first slip-ring 114 and the second slip-ring 116. The first slip-ring 114 and the second slip-ring 116 may be affixed to the first annular portion 164. The second annular portion 168 may be axially offset and disposed radially outwards of the first annular portion 164. The leg portions 166 may axially extend between and couple the first annular portion 164 and the second annular portion 168. The leg portions 166 may include a first leg portion 166a and a second leg portion 166b. The first leg portion 166a and the second leg portion 166b may be axially aligned and circumferentially offset from one another. The second annular portion 168 may be affixed to the terminal ends 140. For example, the terminal ends 140 may radially extend from the second annular portion 168.

The terminal ends 140 may be axially offset and disposed radially outward of the first slip-ring 114 and the second slip-ring 116. The terminal ends 140 may include a first terminal end 140a and a second terminal end 140b. The first slip-ring 114 and the second slip-ring 116 may be electrically connected to respective of the first terminal end 140a and the second terminal end 140b within the overmolding 138. For instance, the first slip-ring 114 may be electrically connected to the first terminal end 140a within the first annular portion 164, the first leg portion 166a, and the second annular portion 168. By way of another instance, the second slip-ring 116 may be electrically connected to the second terminal end 140b within the first annular portion 164, the second leg portion 166b, and the second annular portion 168. An electrically conductive material (not depicted) may be disposed within the overmolding 138 by which the first slip-ring 114 and the second slip-ring 116 are electrically connected to the terminal ends 140.

The first plate ring 102, the first brush assembly 108, the first slip-ring 114, and the first terminal end 140a may define a first pole. Similarly, the second plate ring 104, the second brush assembly 110, the second slip-ring 116, and the second terminal end 140b may define a second pole. The first pole and the second pole may be used in tandem, so that an electrical positive pole and a negative pole can be provided via the current collector 100. One of the first pole and the second pole may be assigned to a positive pole, with the other being assigned to a negative pole.

Heat may be generated as the rolling brushes 136. The current collector 100 may be oil-cooled. The current collector 100 may be oil-cooled via an oil inlet 154, circumferential grooves 152, and/or an oil bores 150.

The housing plate 106 may define the oil inlet 154. For example, the plate portion 146 and the rim portion 148 may collectively define the oil inlet 154. The oil inlet 154 may be a radial blind hole. For example, the oil inlet 154 may be a radial blind hole starting from the rim portion 148 through a portion of the plate portion 146. The oil inlet 154 may be disposed radially outwards of an axial through hole defined by the plate portion 146. The oil inlet 154 may be circumferentially disposed between pairs of the fastener holes 158 and/or pairs of the fastener holes 160. The oil inlet 154 may extend radially through the rim portion 148 and a portion of the plate portion 146. A diameter of the oil inlet 154 may be less than an axial thickness of the plate portion 146.

The housing plate 106 may also define the circumferential grooves 152 (e.g., a pair of the circumferential grooves 152). For example, the plate portion 146 may define circumferential grooves 152. The circumferential grooves 152 may be concentric to the center axis of the current collector 100. The circumferential grooves 152 may be defined through a portion of the thickness of the plate portion 146. The circumferential grooves 152 may be disposed on the opposing axial faces of the plate portion 146.

The oil inlet 154 may fluidically couple with the circumferential grooves 152. For example, the oil inlet 154 may fluidically couple with the circumferential grooves 152 by forming a T-shape within the plate portion 146.

The inner brush carriers 128 may define the oil bores 150. The oil bores 150 may be holes defined axially through a portion of the inner brush carriers 128 to the brush holes 172. The oil bores 150 may be disposed radially adjacent to and circumferentially aligned with the rolling brushes 136. The oil bores 150 may fluidically couple the circumferential grooves 152 with the brush holes 172.

The current collector 100 may receive oil via the oil inlet 154. The oil may be pumped radially through the oil inlet 154 and diverted axially to each of the circumferential grooves 152. The oil may flow circumferentially around the circumferential grooves 152. The oil may flow from the circumferential grooves 152 axially through the oil bores 150 to the brush holes 172. The oil may then cool the brush holders 134, the rolling brushes 136, the first slip-ring 114, and/or the second slip-ring 116. The oil may exit the current collector along the first slip-ring 114 and/or the second slip-ring 116 with the waste heat.

The oil may act as a resistor between the rolling brushes 136 and the raceways 162. The force of the springs 132 may be selected to be sufficiently strong to squeeze out the oil and maintain rolling contact. For example, the force of the springs 132 may maintain the rolling contact and overcome the centripetal forces and/or capillary films forces of the oil.

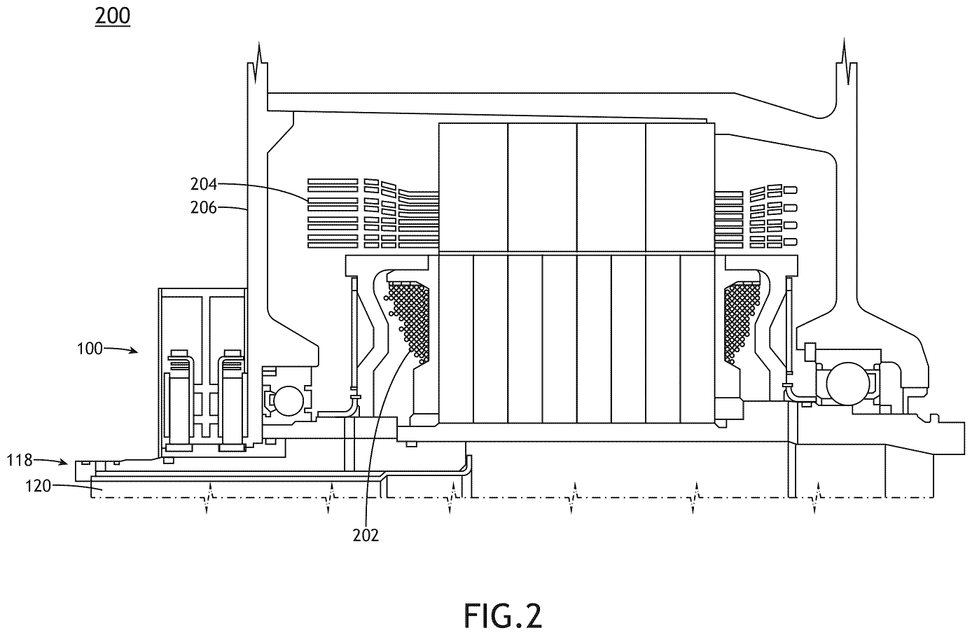

FIG. 2 illustrates a dynamo-electric machine 200, in accordance with one or more embodiments of the present disclosure. The dynamo-electric machine 200 may be an electric motor and/or an electric generator. For example, the dynamo-electric machine 200 may convert electrical energy into mechanical energy, vice versa, or both. The dynamo-electric machine 200 may be an electric motor and/or an electric generator. The dynamo-electric machine 200 may be a traction motion within a drive train of a hybrid or fully electric motor vehicle. The motor vehicles may be land vehicles that are moved by mechanical power without being tied to railway tracks. The motor vehicles may be passenger cars, mopeds, light motor vehicles, motorcycles, buses, tractors, or the like. The dynamo-electric machine 200 may operate at select speeds. For example, the dynamo-electric machine 200 speeds of greater than 5,000 rpm, greater than 10,000 rpm, greater than 12,500 rpm, or the like.

The dynamo-electric machine 200 may include one or more components, such as, but not limited to, the current collector 100, rotor winding 202, a stator 204, and/or a motor housing 206.

The rotor 118 may include the rotor winding 202. The rotor winding 202 may be affixed to the shaft 120. The first plate ring 102 and the second plate ring 104 may receive current from an external power source (not depicted) via the terminal portions 144. The current collector 100 may then supply current from the first plate ring 102 and the second plate ring to the terminal ends 140. The terminal ends 140 may connect to the rotor winding 202. Thus, the current collector 100 may supply current to the rotor winding 202 as the rotor 118 rotates about the center axis while the first plate ring 102 and the second plate ring 104 are stationary. The rotor winding 202 may be energized via the current from the current collector 100. The rotor winding 202 may generate a magnetic field in response to being energized. The stator 204 may also be configured to generate a magnetic field. The combination of the magnetic fields generated by the rotor winding 202 and the stator 204 may cause the rotor 118 to rotate and generates a torque.

The motor housing 206 may house the current collector 100, the rotor 118, and/or the stator 204. The housing plate 106 may be affixed to the motor housing 206. For example, the housing plate 106 may be affixed to the motor housing 206 via the fasteners 124. The stator 204 may also be affixed to the motor housing. The housing plate 106 may be affixed axially inside or outside of the motor housing 206.

In embodiments, the dynamo-electric machine 200 may be a synchronous motor, such as an electrically excited synchronous motor (EESM). The electrically excited synchronous motor may also be referred to as a doubly fed synchronous motor. The rotor 118 and the stator 204 may be fed with current which is synchronized to the rotation of the rotor 118. For example, an electronic control unit (ECU, not depicted), may synchronize the current to the rotor 118 and the stator 204 with the rotation of the rotor 118. The rotation of the rotor 118 may be detected by a sensor, such as a resolver (not depicted).

The oil may be pumped through the current collector 100 from an oil sump via an oil pump (not depicted) of the dynamo-electric machine 200.

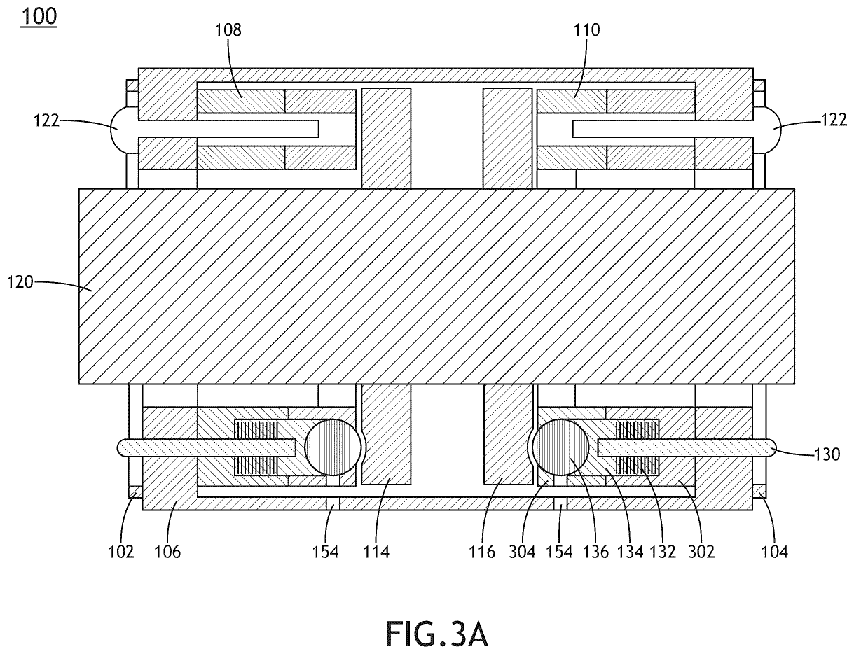

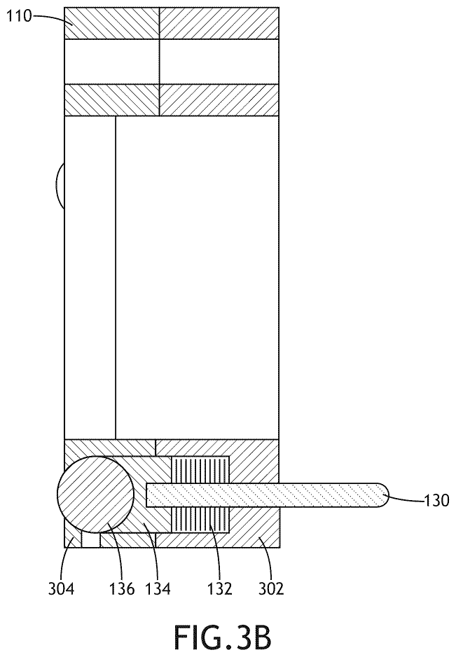

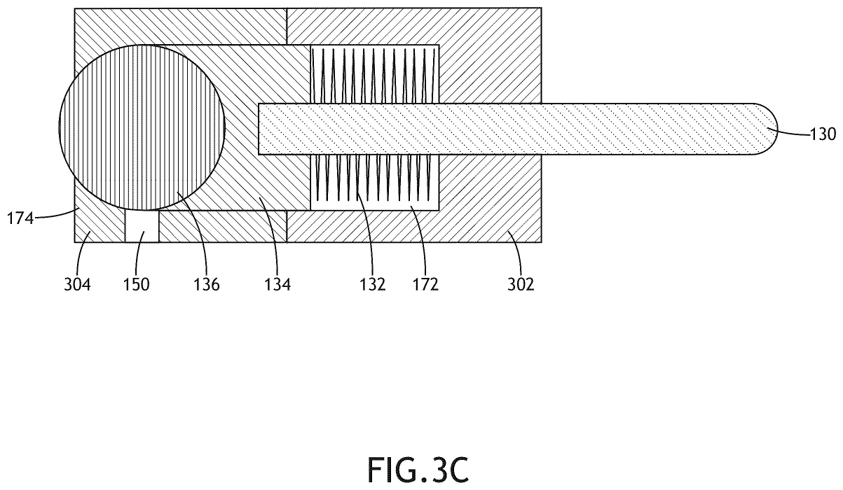

FIGS. 3A-3C illustrate the current collector 100, in accordance with one or more embodiments of the present disclosure.

Although the first brush assembly 108 and the second brush assembly 110 have been described as affixed to opposing axial sides of the housing plate 106, this is not intended as a limitation of the present disclosure. In embodiments, the first brush assembly 108 and the second brush assembly 110 may be affixed axially within the housing plate 106.

Although the first brush assembly 108 and the second brush assembly 110 have been described as including the outer brush carriers 126 and the inner brush carriers 128, this is not intended as a limitation of the present disclosure. In embodiments, the first brush assembly 108 and the second brush assembly 110 may include first axial brush carriers 302 and second axial brush carriers 304. For example, each of the first brush assembly 108 and the second brush assembly 110 may include one of the first axial brush carriers 302 and one of the second axial brush carriers 304.

The first axial brush carriers 302 and the second axial brush carriers 304 may be affixed together. The first axial brush carriers 302 may be axially offset from and disposed radially aligned with the second axial brush carriers 304. The first axial brush carriers 302 and the second axial brush carriers 304 may be electrically conductive or electrically non-conductive without impacting the function of the current collector 100. The first axial brush carriers 302 and the second axial brush carriers 304 may be affixed to the housing plate 106. For example, the fasteners 122 may affix the second axial brush carriers 304 to the housing plate 106. The second axial brush carriers 304 may abut the first axial brush carriers 302 to the housing plate 106, thereby affixing the first axial brush carriers 302 to the housing plate 106.

The first slip-ring 114 and the second slip-ring 116 may be radially aligned with the rolling brushes 136. The first slip-ring 114 and the second slip-ring 116 may be disposed axially between the first brush assembly 108 and the second brush assembly 110. The second axial brush carriers 304 of the first brush assembly 108 may be disposed axially between the first axial brush carriers 302 of the first brush assembly 108 and the first slip-ring 114. Similarly, the second axial brush carriers 304 of the second brush assembly 110 may be disposed axially between the first axial brush carriers 302 of the second brush assembly 110 and the second slip-ring 116.

The first axial brush carriers 302 and the second axial brush carriers 304 may include a select shape. For example, the first axial brush carriers 302 and the second axial brush carriers 304 may be a star shape, a circle, or the like. For instance, the star shape may be a six-pointed star shape. The star shape may define the vertices 170. The discussion of the vertices 170 of the outer brush carriers 126 is incorporated herein by reference as to the vertices 170 of the first axial brush carriers 302 and the second axial brush carriers 304.

The first axial brush carriers 302 and the second axial brush carriers 304 may cooperatively define brush holes 172. Portions of the brush holes 172 defined by the first axial brush carriers 302 and portions of the brush holes 172 defined by the second axial brush carriers 304 may be circumferentially aligned by which the brush holes 172 may be cooperatively defined. The portions of the brush holes 172 defined by the second axial brush carriers 304 may be through holes. The portions of the brush holes 172 defined by the first axial brush carriers 302 may be blind holes. The brush holes 172 may extend axially through the second axial brush carriers 304 up through a portion of the first axial brush carriers 302. The brush holes 172 may be defined in a polar array about the center axis of the current collector 100.

The first axial brush carriers 302 and the second axial brush carriers 304 may carry the wires 130, the springs 132, the brush holders 134, and the rolling brushes 136. The brush holes 172 may also be referred to as brush guides, radial channels, or the like. The brush holes 172 may carry the wires 130, the springs 132, the brush holders 134, and the rolling brushes 136. For example, an axially-inner portion of the wires 130, the springs 132, the brush holders 134, and an axially-inner portion of the rolling brushes 136 may be disposed within the brush holes 172. An axially-outer portion of the wires 130 may extend through the brush holes 172 and be disposed axially outwards of brush holes 172. An axially-outer portion of the rolling brushes 136 may extend through the brush holes 172 and be disposed outwards of the brush holes 172.

The brush holes 172 may prevent a first axial end of the wires 130 which are coupled to the brush holders 134, the springs 132, the brush holders 134, and/or the rolling brushes 136 from radial translation and/or circumferential translation relative to the first axial brush carriers 302 and the second axial brush carriers 304. The first axial end of the wires 130 which are coupled to the brush holders 134, the first axial end of the end of the springs 132 which are coupled to the brush holders 134, the brush holders 134, and/or the rolling brushes 136 may be configured to axially translate relative to the first axial brush carriers 302 and the second axial brush carriers 304 along the brush holes 172.

A first axial end of the wires 130 may be coupled to the brush holders 134. A second axial end of the wires 130 may be coupled to the respective of the first plate ring 102 and the second plate ring 104. The wires 130 may be coupled to the annular portion 142 of the first plate ring 102 and the second plate ring 104. The second axial end of the wires 130 may include a select shape. For example, the second axial end of the wires 130 may include the U-shape. The U-shape may provide elastic deformation and enable axial movement of the wires 130.

The springs 132 may couple between the brush holders 134 and the first axial brush carriers 302. For example, a first axial end of the springs 132 may couple to the brush holders 134 and a second axial end of the springs 132 may couple to the first axial brush carriers 302. The springs 132 may force the brush holders 134 axially (e.g., spring-load). The wires 130 may radially extend through an inner diameter of the springs 132.

The brush holders 134 may be disposed axially between both the wires 130 and the springs 132 and the rolling brushes 136. The axial end of the brush holders 134 to which the wires 130 and the springs 132 are coupled may be flat. The axial end of the brush holders 134 which couples to the rolling brushes 136 may include a curvature. The curvature may conform to the rolling brushes 136.

The rolling brushes 136 may be forced axially away from the first axial brush carriers 302 by the springs 132 via the brush holders 134. The rolling brushes 136 of the first brush assembly 108 and the second brush assembly 110 may be forced against respective of the first slip-ring 114 and the second slip-ring 116. For example, the rolling brushes 136 may be forced against a raceway of the first slip-ring 114 and the second slip-ring 116.

The current collector 100 may receive oil via the oil inlet 154. The oil may be pumped radially through the oil inlet 154 directly to the oil bores 150 to the brush holes 172. The oil may then cool the brush holders 134, the rolling brushes 136, the first slip-ring 114, and/or the second slip-ring 116. The oil may exit the current collector along the first slip-ring 114 and/or the second slip-ring 116 with the waste heat.

It is contemplated that one challenge with the first brush assembly 108 and the second brush assembly 110 including the first axial brush carriers 302 and the second axial brush carriers 304, may be the ease-of-assembly of the first brush assembly 108 and the second brush assembly 110. For example, the first brush assembly 108 and the second brush assembly 110 may be difficult to assembly with the first axial brush carriers 302 and the second axial brush carriers 304 disposed axially within the housing plate 106.

Referring generally again to the figures. Electrically conductive may refer to a material which may conduct electricity. For example, a component which is electrically conductive may be made of brass, copper, steel, aluminum, tin, carbon, alloys thereof, or another electrically conductive material. Electrically non-conductive may refer to a material which may not conduct electricity. For example, a component which is electrically non-conductive may be made of an electrically non-conductive plastic or another electrically conductive material.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, the term “axial” and derivatives thereof, such as “axially,” shall be understood to refer to a direction along the axis. The term “coaxial” shall be understood to refer to a common axis. Further, the term “radial” and derivatives thereof, such as “radially,” shall be understood in relation to the axis. For example, “radially outward” refers to further away from the axis, while “radially inward” refers to nearer to the axis. The term “circumference” or derivatives thereof, such as “circumferentially”, may also be defined in reference to the center axis.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 current collector
102 first plate ring
104 second plate ring
106 housing plate
108 first brush assembly
110 second brush assembly
112 slip-ring module
114 first slip-ring
116 second slip-ring
118 rotor
120 shaft
122 fasteners
124 fasteners
126 outer brush carriers
128 inner brush carriers
130 wires
132 springs
134 brush holders
136 rolling brushes
138 overmolding
140 terminal ends
140a first terminal end
140b second terminal end
142 annular portion
144 terminal portion
146 plate portion
148 rim portion
150 oil bores
152 circumferential grooves
154 oil inlet
156 holes
158 fastener holes
160 fastener holes
162 raceways
164 first annular portion
166 leg portions
166a first leg portion
166b second leg portion
168 second annular portion
170 vertices
172 brush holes
174 inward taper
200 dynamo-electric machine
202 rotor winding
204 stator
206 motor housing
302 first axial brush carriers
304 second axial brush carriers

What is claimed:

1. A current collector comprising:
a first plate ring;
a second plate ring;
a housing plate, wherein the housing plate is electrically non-conductive;
a first brush assembly, wherein the first plate ring and the first brush assembly are affixed to a same axial side of the housing plate;
a second brush assembly, wherein the second plate ring and the second brush assembly are affixed to a same axial side of the housing plate, wherein the first brush assembly and the second brush assembly comprise a plurality of wires, a plurality of springs, a plurality of brush holders, and a plurality of rolling brushes; and
a slip-ring module, wherein the slip-ring module is configured to rotate relative to the housing plate, the first brush assembly, and the second brush assembly about a center axis, wherein the slip-ring module comprises a first slip-ring and a second slip-ring, wherein the plurality of rolling brushes of the first brush assembly and the second brush assembly include rolling contact with respective of the first slip-ring and the second slip-ring as the slip-ring module rotates about the center axis, wherein the plurality of wires, the plurality of brush holders, and the plurality of rolling brushes of the first brush assembly and the second brush assembly are configured to transmit current between respective of the first plate ring and the second plate ring and respective of the first slip-ring and the second slip-ring.

2. The current collector of claim 1, wherein the first plate ring and the second plate ring are affixed to opposing axial sides of the housing plate, wherein the first brush assembly and the second brush assembly comprise an outer brush carrier and an inner brush carrier, wherein the inner brush carrier is axially aligned with and disposed radially within the outer brush carrier, wherein the outer brush carrier and the inner brush carrier carry the plurality of wires, the plurality of springs, the plurality of brush holders, and the plurality of rolling brushes.

3. The current collector of claim 2, wherein the plurality of wires of the first brush assembly and the second brush assembly couple between respective of the first plate ring and the second plate ring and the plurality of springs, wherein the plurality of springs couple between the plurality of brush holders and the outer brush carrier, wherein the plurality of brush holders are disposed radially inwards of the plurality of wires and the plurality of springs, wherein the plurality of brush holders are disposed radially outwards of the plurality of rolling brushes, wherein the plurality of rolling brushes are forced radially inwards by the plurality of springs via the plurality of brush holders.

4. The current collector of claim 3, wherein the plurality of springs are compression springs, wherein the plurality of wires radially extend through an inner diameter of the plurality of springs.

5. The current collector of claim 4, wherein radially-inner ends of the plurality of wires, radially-inner ends of the plurality of springs, the plurality of brush holders, and the plurality of rolling brushes are configured to radially translate relative to the outer brush carrier and the inner brush carrier, wherein the radially-inner ends of the plurality of springs and the radially-inner ends of the plurality of wires couple to radially-outer ends of the plurality of brush holders, wherein the radially-outer ends of the plurality of springs couple to the outer brush carrier, wherein radially-outer ends of the plurality of wires of the first brush assembly and the second brush assembly couple to respective of the first plate ring and the second plate ring.

6. The current collector of claim 5, wherein the radially-outer ends of the plurality of wires comprises a U-shape.

7. The current collector of claim 5, wherein the outer brush carrier and the inner brush carrier cooperatively define a plurality of brush holes, wherein the plurality of brush holes extend radially outwards from an inner diameter of the inner brush carrier up through a portion of the outer brush carrier, wherein the plurality of brush holes carry the plurality of wires, the plurality of springs, the plurality of brush holders, and the plurality of rolling brushes, wherein the plurality of brush holes include an inward taper at an inner diameter of the inner brush carrier, wherein the inward taper retains the plurality of rolling brushes within the plurality of brush holes.

8. The current collector of claim 7, wherein the outer brush carrier comprises a star shape defining a plurality of vertices, wherein the radially-outer ends of the plurality of springs couple to plurality of vertices within the plurality of brush holes.

9. The current collector of claim 7, wherein the housing plate defines an oil inlet and a pair of circumferential grooves, wherein the oil inlet fluidically couples with the pair of circumferential grooves, wherein the inner brush carrier defines an oil bore, wherein the oil bore fluidically couples the pair of circumferential grooves with the plurality of brush holes.

10. The current collector of claim 9, wherein the current collector is configured to be oil-cooled via the oil inlet, the pair of circumferential grooves, and the oil bore.

11. The current collector of claim 9, wherein the housing plate defines a plate portion and a rim portion, wherein the rim portion is disposed radially around and axially extends from the plate portion, wherein the plate portion defines the pair of the circumferential grooves, wherein the plate portion and the rim portion collectively define the oil inlet.

12. The current collector of claim 1, wherein the first brush assembly and the second brush assembly are affixed axially within the housing plate, wherein the first brush assembly and the second brush assembly comprise an first axial brush carrier and a second axial brush carrier, wherein the first axial brush carrier is axially offset from and radially aligned with the second axial brush carrier, wherein the first axial brush carrier and the second axial brush carrier carry the plurality of wires, the plurality of springs, the plurality of brush holders, and the plurality of rolling brushes.

13. The current collector of claim 1, wherein the plurality of rolling brushes comprise one of ball rollers, needle rollers, or taper rollers.

14. The current collector of claim 13, wherein the plurality of rolling brushes comprise the ball rollers, wherein a radially-inner end of the plurality of brush holders includes a curvature conforming to the plurality of rolling brushes, wherein the first slip-ring and the second slip-ring define a raceway, wherein the plurality of rolling brushes abut to and are configured to roll on the raceway.

15. The current collector of claim 1, wherein the slip-ring module comprises an overmolding, wherein the overmolding electrically insulates the first slip-ring and the second slip-ring from each other.

16. The current collector of claim 15, wherein the slip-ring module comprises a first terminal end and a second terminal end, wherein the first slip-ring and the second slip-ring are electrically connected to respective of the first terminal end and the second terminal end within the overmolding.

17. The current collector of claim 16, wherein the first terminal end and the second terminal end are axially offset and disposed radially outward of the first slip-ring and the second slip-ring.

18. The current collector of claim 17, wherein the overmolding comprises a first annular portion, a first leg portion, a second leg portion, and a second annular portion, wherein the first annular portion and the second annular portion are concentric to the center axis, wherein the first annular portion is disposed radially inwards of and axially aligned with the first slip-ring and the second slip-ring, wherein the first leg portion and the second leg portion extend between and couple the first annular portion and the second annular portion, wherein the first terminal end and the second terminal end radially extend from the second annular portion.

19. The current collector of claim 1, wherein the first plate ring and the second plate ring include an annular portion and terminal portion, wherein the terminal portion extends from an outer diameter of the annular portion, wherein the plurality of wires are coupled to the annular portion.

20. A dynamo-electric machine comprising:
a current collector comprising:
a first plate ring;
a second plate ring;
a housing plate, wherein the housing plate is electrically non-conductive;
a first brush assembly, wherein the first plate ring and the first brush assembly are affixed to a same axial side of the housing plate;
a second brush assembly, wherein the second plate ring and the second brush assembly are affixed to a same axial side of the housing plate, wherein the first brush assembly and the second brush assembly comprise a plurality of wires, a plurality of springs, a plurality of brush holders, and a plurality of rolling brushes; and
a slip-ring module, wherein the slip-ring module is configured to rotate relative to the housing plate, the first brush assembly, and the second brush assembly about a center axis, wherein the slip-ring module comprises a first slip-ring and a second slip-ring, wherein the plurality of rolling brushes of the first brush assembly and the second brush assembly include rolling contact with respective of the first slip-ring and the second slip-ring as the slip-ring module rotates about the center axis, wherein the plurality of wires, the plurality of brush holders, and the plurality of rolling brushes of the first brush assembly and the second brush assembly are configured to transmit current between respective of the first plate ring and the second plate ring and respective of the first slip-ring and the second slip-ring;
a rotor, wherein the rotor comprises a shaft and a rotor winding, wherein the slip-ring module is affixed to the shaft, wherein the current collector is configured to supply current to the rotor winding as the rotor rotates about the center axis;
a stator; and
a motor housing, wherein the motor housing houses the rotor and the stator, wherein the housing plate and the stator are affixed to the motor housing.
